(19) United States
(12) Patent Application Publication
(10) Pub. No.: US 2011/0149934 A1
(43) Pub. Date: Jun. 23, 2011

(54) METHOD AND APPARATUS FOR MOBILE DEVICE LOCATION TRACKING USING WIRELESS LOCAL AREA NETWORKS

(76) Inventors: LEWIS William DICKSON, JR., Sarasota, FL (US); Sanford Burris, Kirtland, OH (US)

(21) Appl. No.: 12/976,300

(22) Filed: Dec. 22, 2010

Related U.S. Application Data
(60) Provisional application No. 61/288,976, filed on Dec. 22, 2009.

(51) Int. Cl. H04W 4/02

(52) U.S. Cl. 370/338

(57) ABSTRACT

Tracking devices are provided that use wireless local area networks to determine location. The tracking devices receive identification data from at least one local are network in the vicinity of the tracking device, and store tracking data that includes the identification data as well as a date and time stamp indicating when the identification data was received. The devices can transmit the tracking data to a server, and the location of the tracking device can be determined using the tracking data.

### RELATED APPLICATIONS

This application claims the benefit of U.S. Provisional Patent Application Ser. No. 61/288,976, filed on Dec. 22, 2009, currently pending.

### BACKGROUND

The present technology relates to tracking devices that use wireless local-area-network technology to determine location.

Some currently known tracking devices use global positioning system (GPS) technology, which is a satellite based technology that tends to be limited to use outdoors due to the need for an unobstructed “line of site” between the satellites and the device.

Other known tracking devices employ radio frequency identification (RFID), which uses communication via radio waves to exchange data between a reader and an electronic tag. Some RFD tracking devices can act as a beacon within a specific geographic area, such as a hospital or corporate campus, by transmitting signals that can be identified and tracked by a specific wireless local-area-network (WLAN) with which the RFID devices are associated.

### BRIEF SUMMARY

The present technology relates to tracking devices that use wireless local-area-network (WLAN) technology to determine location, and more particularly relates to location determination using wireless local-area-network (WLAN) technology that complies with IEEE 802.11.

In one aspect, a method performed by a tracking device is provided. The tracking method includes the steps of: receiving identification data from at least one local are network with a transceiver of the tracking device; producing tracking data with a microprocessor of the tracking device; storing the tracking data in memory of the tracking device; and transmitting the tracking data with the transceiver of the tracking device to a server. The tracking data includes the identification data and a date and time stamp indicating when the identification data was received.

In another aspect, a method of tracking a tracking device is provided. The method includes providing a tracking device that includes a transceiver that receives identification data from at least one local are network and transmits tracking data to a server, a microprocessor that produces tracking data, the tracking data including the identification data and a date and time stamp indicating when the identification data was received, and memory that stores the tracking data. The method also includes receiving identification data from at least one local are network with the transceiver of the tracking device; and producing tracking data with the microprocessor of the tracking device. The tracking data includes the identification data and a date and time stamp indicating when the identification data was received. The method further includes storing the tracking data in the memory of the tracking device; and transmitting the tracking data with the transceiver of the tracking device to the server.

### BRIEF DESCRIPTION OF SEVERAL VIEWS OF THE DRAWINGS

Specific examples have been chosen for purposes of illustration and description, and are shown in the accompanying drawings, forming a part of the specification.

FIG. 1 illustrates one example of a tracking device of the present technology.

FIG. 2 illustrates a block diagram of a method of using a tracking device of the present technology for location determination.

FIG. 3 illustrates one application of a location determination method using a tracking device of the present technology.

### DETAILED DESCRIPTION

The present technology relates to tracking devices that use wireless local-area-network (WLAN) technology to determine location. The tracking devices are not limited to use within a single wireless local-area-network. Instead, tracking devices of the present technology make use of a plurality of existing wireless local-area-networks, often referred to as being “hot spots.” For example, it has become common for commercial retailers, particularly in the hospitality and food service industries, to provide public, open access wireless local-area-networks for use by their customers. Tracking devices of the present technology can use such wireless local-area-networks, and are thus not tied limited to any specific geographic location, and function indoors as well as outdoors.

The tracking devices can be used in a wide variety of applications, including but not limited to, being incorporated into a collar for tracking pets; being incorporated into a bracelet, a pendant, a belt, or an ankle bracelet for tracking pets or people, including children, the elderly, or even criminal offenders confined to defined geographical limitations; being attached to vehicles for vehicle tracking; and being attached to personal property, such as televisions, phones, for tracking stolen property.

Tracking devices of the present technology use computerized wireless communication to receive and transmit signals in accordance with IEEE 802.11, which is a set of standards carrying out wireless local area network (WLAN) computer communication in the 2.4, 3.6 and 5 GHz frequency bands. For example, preferred embodiments of the tracking devices of the present technology are WiFi® compatible, meaning that they are able to receive from and transmit to local area networks certified by the Wi-Fi Alliance.

Tracking devices of the present technology can include hardware such as a transceiver, a software controlled microprocessor sub-system, and memory. Tracking devices can also include a power source, such as a battery or a solar panel, or power can be supplied to the tracking device from an external source, such as a 6 volt or 12 volt electrical supply. Tracking devices may also include one or more sensors, including but not limited to an accelerometer, a thermometer, or a motion sensor. In one example, a tracking device of the present technology can be combined with a motion sensor, and can be placed on an article of personal property, such as a television. The motion sensor can detect movement within its scanning area, which may indicate a theft in progress, and the tracking device can be used to determine the location of the personal property when a theft has occurred.

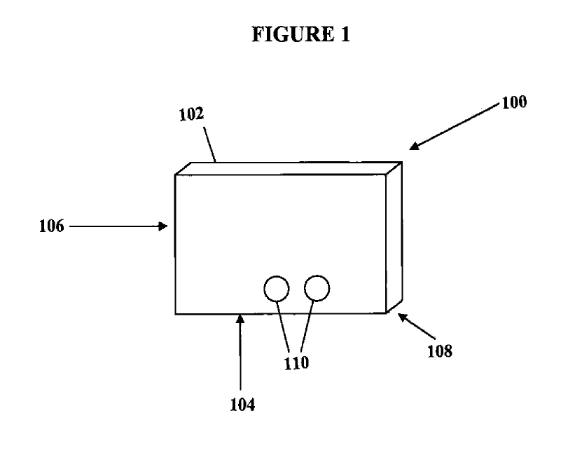

FIG. 1 illustrates one example of a tracking device 100 of the present technology having a housing 102 that is rectangular in shape, including a length 104, a width 106, and a thickness 108. The weight, shape and dimensions of the housing of the tracking devices of the present technology are not particularly limited. In at least some examples, it is desirable for tracking devices to be lightweight, so that they can be easily carried by a person or animal. For example, some tracking devices can have a weight that is from about 20 grams to about 100 grams, or from about 30 grams to about 50 grams. In some examples, tracking devices may be as small as a book of matches, being up to about 3 inches long, up to about 3 inches wide, and up to about 1 inch thick. In some examples, the tracking devices can have a length from about 0.5 inches to about 3 inches, a width from about 0.5 inches to about 2 inches, and a thickness from about 0.2 inches to about 0.75 inches. The tracking devices may be larger or smaller depending upon the application in which they are being used and any additional components that are incorporated into the tracking device. The housing for tracking devices can also have any suitable shape, including, for example, a rectangle, square, trapezoid, triangle, circle oval, or any regular or non-regular shape.

Tracking devices may also include at least one display, which can be a light source, such as the two light emitting diodes 110 on tracking device 100, in order to provide information to a user regarding the operation of the tracking device.

Tracking devices of the present technology can be combined with, or incorporated into, other devices, such as memory cards, bracelets, pendants, collars, or ankle bracelets. For example, a tracking device may be in the form of a Secure Digital (SD) card or other removable memory device, or as a standalone, non-removable device.

Tracking devices of the present technology listen for, receives data from, and can transmit data to, at least one wireless local are network, and preferably from a plurality of wireless local are networks, in the vicinity of the tracking device. A wireless local area network can be considered to be in the vicinity of the tracking device when the tracking device is in the coverage range of the wireless local area network, and is thus capable of receiving data from an access point of the wireless local area network. The tracking device preferably operates with wireless local area networks that are in accordance with IEEE 802.11.

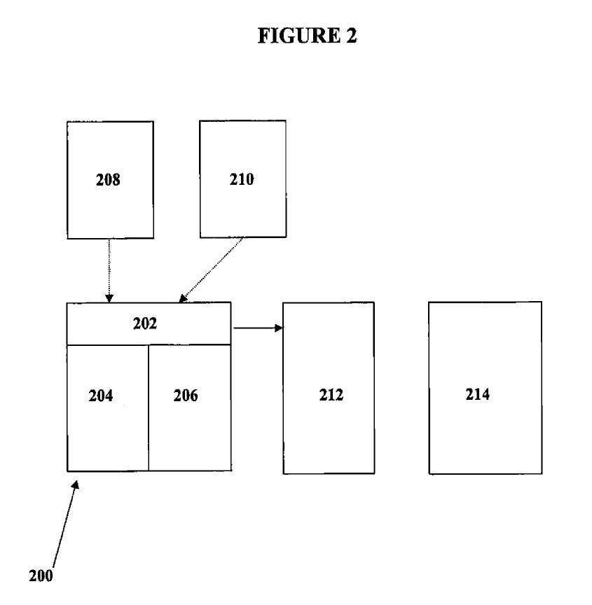

As shown in FIG. 2, a tracking device 200 includes a wireless local area network transceiver 202, a microprocessor 204, and memory 206. Tracking device 200 can receive identification data from an access point, or signal source, of a first wireless local are network 208 in the vicinity of the tracking device 200. The identification data can include information such as, for example, the service set identifier (SSID), media access control (MAC) address, the received signal strength (RSSI), or preferably a combination of thereof. The tracking device 200 may also receive identification data from an access point, or signal source of a second wireless local are network 210 in the vicinity of the tracking device 200. The first and second wireless local area networks may provide open access, allowing any compatible device to use the wireless local area network to transmit data, or may provide limited access, such as only allowing transmission by authorized users. Some limited access local area networks can be encrypted, and an access key, such as a password, may be needed to transmit data using the wireless local area network.

When the tracking device receives identification data from an access point, or signal source, of a wireless local are network, the microprocessor 204 of the tracking device 200 produces a tracking data and stores the data in the memory 206 of the tracking device. The tracking data includes the identification data received from the wireless area local network, and also includes a date and time stamp indicating when the identification data was received from the wireless area local network.

When the tracking device receives identification data from an access point, or signal source, of a wireless local are network 212 to which the tracking device has access, such as when the wireless local area network provides open access or when the tracking device has the key necessary to access an encrypted wireless local area network, the tracking device can use the local area network 212 to access the Internet and transmit the tracking data it has saved in the memory 206 to a server 214. The server 214 can use the tracking data to determine the location of the tracking device.

For example, the server 214 can include hardware and software that allows the server to access location information for the identification data received from an access point of a wireless local are network, and can perform one or more algorithms to determine location information for the tracking device, including at least the last known location of the tracking device, which may also be the current location of the tracking device if it has not moved since it transmitted the tracking data. The server can determine the location of the tracking device over time, thus establishing the path of travel of the tracking device over time.

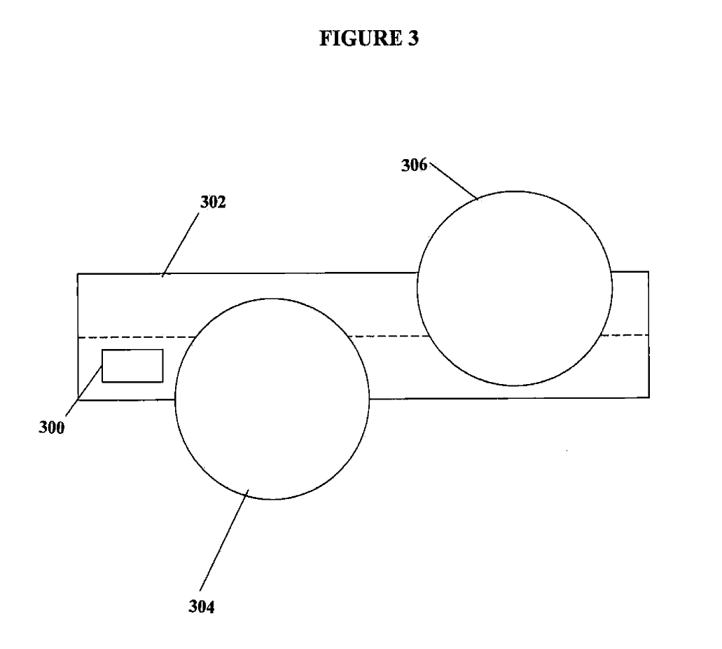

As illustrated in FIG. 3, a vehicle 300 equipped with a tracking device of the present technology can move down the road 302. As the vehicle 300 travels down the road 302, it travels first into the coverage area of a first wireless area local network 304, and then into the coverage area of a second wireless area local network 306. At a first point in time, as the vehicle passes through the coverage area of a first wireless area local network 304, the tracking device of the vehicle 300 receives identification data from an access point of the first wireless area local network 304. The microprocessor of the tracking device produces a first set of tracking data and stores the data in the memory of the tracking device. The first set tracking data includes the identification data received from the first wireless area local network 304, and a date and time stamp indicating when the identification data was received from the first wireless area local network 304. At a second point in time, as the vehicle passes through the coverage area of a second wireless area local network 306, the tracking device of the vehicle 300 receives identification data from an access point of the second wireless area local network 306. The microprocessor of the tracking device produces a second set of tracking data and stores the data in the memory of the tracking device. The second set of tracking data includes the identification data received from the second wireless area local network 306, and a date and time stamp indicating when the identification data was received from the second wireless area local network 306. If, for example, the second wireless area local network 306 includes an open access point, the tracking device can transmit the first and second tracking data sets to a server. The server can receive the first and second tracking data sets, and a microprocessor of the server can determine location data from the tracking data. The location data includes the locations of the tracking device at the first and second points in time.

### EXAMPLE

A tracking device of the present technology was made that had the following hardware characteristics:
Full 802.11b WiFi transmit and receive functions
ISO 24730 Transmit functionality
Single-axis 125 kHz Magnetic receiver
EPC Generation 1, Class One active RFID interface
WiFi Antenna Diversity
20 dBm Wi-Fi output power
Motion sensor
Temperature sensor
Sensor expansion connector
General purpose push button
Dual LEDS
CR123A 1500 mAH 3.0V replaceable battery
Dual UARTS for application and debug
External power interface/control via a TIM module

The tracking device had a length of about 65.4 mm (2.58″), a width of about 41.4 mm (1.63″), and a thickness of about 19.0 mm (0.75″). The tracking device had a weight of about 42 grams.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A tracking method performed by a tracking device, the tracking method comprising the steps of
receiving identification data from at least one local are network with a transceiver of the tracking device;
producing tracking data with a microprocessor of the tracking device, the tracking data including the identification data and a date and time stamp indicating when the identification data was received;
storing the tracking data in memory of the tracking device; and
transmitting the tracking data with the transceiver of the tracking device to a server.

2. The method of claim 1, wherein the transceiver receives identification data from a plurality of wireless local-area-networks.

3. The method of claim 1, wherein the tracking device receives and transmits data in accordance with IEEE 802.11.

4. The method of claim 1, wherein the tracking device comprises a transceiver, a software controlled microprocessor sub-system, and memory.

5. The method of claim 1, wherein the tracking device comprises a power source.

6. The method of claim 5, wherein the power source is a battery or a solar panel.

7. The method of claim 1, wherein the identification data comprises information selected from the group consisting of a service set identifier (SSID), a media access control (MAC) address, a received signal strength (RSSI), and a combination of thereof.

8. A method of tracking a tracking device, the method comprising the steps of:
providing a tracking device comprising a transceiver that receives identification data from at least one local are network and transmits tracking data to a server, a microprocessor that produces tracking data, the tracking data including the identification data and a date and time stamp indicating when the identification data was received, and memory that stores the tracking data;
receiving identification data from at least one local are network with the transceiver of the tracking device;
producing tracking data with the microprocessor of the tracking device, the tracking data including the identification data and a date and time stamp indicating when the identification data was received;
storing the tracking data in the memory of the tracking device; and
transmitting the tracking data with the transceiver of the tracking device to the server.

9. The method of claim 8, further comprising the step of
determining location data for the tracking device by a microprocessor of the server.

10. The method of claim 8, wherein the transceiver receives identification data from a plurality of wireless local-area-networks.

11. The method of claim 8, wherein the tracking device receives and transmits data in accordance with IEEE 802.11.

12. The method of claim 8, wherein the tracking device comprises a transceiver, a software controlled microprocessor sub-system, and memory.

13. The method of claim 8, wherein the tracking device comprises a power source.

14. The method of claim 8, wherein the identification data comprises information selected from the group consisting of a service set identifier (SSID), a media access control (MAC) address, a received signal strength (RSSI), and a combination of thereof.

15. A tracking device comprising:
a transceiver that receives identification data from at least one local are network and transmits tracking data to a server;
a microprocessor that produces the tracking data, the tracking data including the identification data and a date and time stamp indicating when the identification data was received; and
memory that stores the tracking data.

16. The tracking device of claim 15, wherein the tracking device receives and transmits data in accordance with IEEE 802.11.

17. The tracking device of claim 15, wherein the tracking device further comprises a power source.

18. The tracking device of claim 15, wherein the identification data comprises information selected from the group consisting of a service set identifier (SSID), a media access control (MAC) address, a received signal strength (RSSI), and a combination of thereof.
